(19) United States
(12) Patent Application Publication
(10) Pub. No.: US 2003/0026421 A1
(43) Pub. Date: Feb. 6, 2003

(54) Method for transmitting data with digital watermark access control and devices therefor

(76) Inventor: Jean-Noel Morlet, Le Rheu (FR)

Correspondence Address: PEARNE & GORDON LLP, 526 SUPERIOR AVENUE EAST, SUITE 1200, CLEVELAND, OH, 44114-1484, US

(21) Appl. No.: 10/204,979

(22) PCT Filed: Mar. 6, 2001
(86) PCT No.: PCT/FR01/00657

(51) Int. Cl. H04N 7/167

(52) U.S. Cl. 380/203; 713/176

(57) ABSTRACT

Process of transmission of information with access control as a digital watermark.

The access control information is inserted into the scrambled data in the form of a digital watermark. On reception, the digital watermark is extracted from the received data, the access control information is recovered, and the received data are unscrambled if access is authorized.

Application particularly to the transmission of images.

### TECHNICAL FIELD

The present invention has as its object a process of transmission of information, with access control as a digital watermark, and devices for its implementation. By “transmission” is to be understood both emission and reception. The invention covers a process of emission, a process of reception, a device for emission, a device for reception, and an emission-reception system. The invention can be applied to the transmission of fixed or moving images, of natural or synthetic images of objects, of sounds, of music, etc.

### STATE OF PRIOR ART

Access control technique is widely used today, particularly in the field of television. According to this technique, the information to be transmitted (luminance, chrominance of the points of an image) are first transformed into digital data, these data are scrambled by various algorithms, and then are emitted in scrambled form. The recipient is provided with a security processor in which are included different authorizations for access to one or more services, as well as the keys permitting unscrambling the received data to restore the original image.

In this technique, the access control information relating to a particular service (service number, access criteria, encoded unscrambling key, etc.) are always transmitted separately from the data, necessitating a specific protocol depending on the type of transmission medium. For example, the manner of transmitting access control information in DVB (“Digital Video Broadcasting”) has nothing in common with that used in DAB (“Digital Audio Broadcasting”). Thus there are incompatibilities between these two protocols.

An objective of the present invention is to remedy this disadvantage by suppressing all transmission protocols of access control information.

Another objective is to avoid piracy or the illegal copying of the transmitted information.

### SUMMARY OF THE INVENTION

The invention recommends inserting the access control information into the digital data to be transmitted and in a particular form, i.e., that of a digital watermark, likewise termed “watermarking” in English. The digital watermark is known for marking a work in order to protect it by copyright.

More precisely, the invention thus has as its object a process of emission of information with access control, in which this information is transformed into digital data, these digital data are scrambled, the scrambled digital data are emitted, and furthermore access control information is emitted, characterized in that the access control information is inserted into the scrambled digital data in the form of a digital watermark, and the scrambled digital data are emitted with their digital watermark.

When the digital data are organized in bytes (for example, in 8-bit bytes), the access control information of the digital watermark is inserted into certain bytes in place of certain binary element(s), for example, the least significant binary element. The choice of these bytes is determined by a key.

The emission of the data and of the watermark can take place by any means: by Hertzian means, by wire, by digital cable, by recording medium (for example, by numeric optical disc termed CD), etc.

Although the invention is applied to any form of information, in a preferred mode of embodiment this information corresponds to images. In this case, the scrambling which is effected is such that the original quality of the image becomes degraded, and unscrambling restores its original quality to the image. This degradation can be effected to a degree according to an index of scrambling.

The invention likewise has as its object a process of reception of information with access control, this information having been emitted according to the process just defined, this process being characterized in that the digital watermark is extracted from the received digital data and gives the access control information and, if access is authorized, the scrambled digital data are unscrambled to restore the information.

In the application to images, the emission can take place across the Internet network by an image server, and the reception can take place by a user provided with appropriate equipment. In this case:

the user orders an image from the image server,

the image server inserts a digital watermark in the digital data of the image, degrades the quality of the image by scrambling the digital data of the image according to a selected scrambling index, and transmits the image having degraded quality with the digital watermark,

the user records the received data and uses his equipment to restore its original quality to the image and to display the ordered image.

A fundamental difference must be emphasized between a conventional digital watermark, which marks an image with the object of preserving copyright (“watermarking”), and the watermark used according to the present invention to transmit access conditions. In the first case, the user can be tempted to manipulate the image to cause the marking to disappear. This marking can also be naturally perturbed or even disappear if the image undergoes degradation during transmission or during digital processing such as image compression, for example. In the invention, such manipulations or treatments are excluded, since the information linked to the watermark is necessary in order to obtain the image. In other words, the watermark of the invention is no longer considered as a hindrance to the exploitation of the information but as a necessity for its reception.

The present invention likewise has as its object a device for the emission of information with access control for the implementation of the process which has just been described. This device comprises means for transforming this information into digital data, means for scrambling these data, means for emitting these scrambled data and for emitting access control information. This device is characterized in that it comprises means for inserting the access control information into the digital data in the form of a digital watermark, the means for emission being capable of emitting the scrambled data with the access control information.

This device preferably comprises means for inserting a digital watermark into the data relating to an image, means for degrading the quality of the image by scrambling the digital data of the image according to a selected scrambling index, and means for transmitting with the digital watermark the image having degraded quality.

The present invention likewise has as its object a device for the reception of information with access control, for the implementation of the process already defined. This device comprises means for reception of scrambled data and of access control information, means for verifying whether access is authorized, and means for unscrambling the received data if access is authorized, and means for restoring the information. The device of the invention is characterized in that the reception means is capable of extracting from the received data the digital watermark which they contain, for restoring the access control information and for unscrambling the data if access is authorized.

Preferably, the means for unscrambling the data are means capable of restoring its original quality to an image having degraded quality.

Finally, the present invention has as its object a system comprising at lest one emission device and a plurality of reception devices such as have been described hereinabove.

### BRIEF DESCRIPTION OF THE DRAWINGS

Other characteristics and advantages of the invention will become more clearly apparent on reading the following description with reference to the accompanying drawings, in which

FIG. 1 is a general flow chart illustrating the process of the invention,

FIG. 2 illustrates a secured image distribution service on the Internet network.

### DETAILED DESCRIPTION OF A PARTICULAR EMBODIMENT

The following description relates, by way of explanation, to the case of transmission of BMP (“Bit Map Picture”) images, but the invention is in no way limited to this case.

In this particular embodiment, the process can make use of two distinct units:

An image server comprising means for scrambling the image and for insertion of the digital watermark containing access control information and various limitations,

A user equipment having a viewer, a watermark extraction algorithm, and an unscrambling algorithm.

These two units will be described in the case of a personal computer (PC) operating with Windows™ 95/98 or NT™ software.

(a) Acquisition of Access Control Parameters for the Server

Different access control parameters can be inserted into the image in the form of a digital watermark, particularly:

Screen copy deactivation parameter: an image unscrambled by the user's equipment can easily be restored by copying or screen capture; these functions of copying and screen capture can be deactivated in the equipment for all the applications running on the computer;

Utilization limitation parameter: the number of utilizations of an image can be limited by giving the maximum authorized number of utilizations (WM-NEMAX-UTIL) and the reference of the image (WM-REF-IMAGE);

Recipient parameter: use can be reserved to a single user by inserting his user reference (WM-REF-USER) or the reference to a service (WM-REF-SERVICE).

(b) Insertion of the Digital Watermark

The original image is a BMP “bitmap” image in spatial coding in which each pixel is represented by its three RGB components (Red-Green-Blue). The BMP file has the following structure:

a header in which the image characteristics (size, pointer on the bitmap, number of coding bits, number of planes, color palette, etc.) are defined;

a zone containing the information for the whole image.

Certain 8-bit bytes are selected to receive the information bits of the watermark, as will be explained hereinafter. Each byte thus selected will be termed a “watermark byte” hereinafter. To mark such a byte, it is sufficient to replace a binary element (or “bit”), for example, the least significant bit (b₀), by the binary element to be inserted. The variation of the value of the watermark byte with respect to its old value is at most 1/256, which, in a chrominance component, cannot be seen by the eye.

To insert a watermark composed of n bits into a zone of the bitmap, this zone is divided into n equal portions, and the byte is marked corresponding to the start of each portion thus defined. The address of the watermark byte corresponding to the bit i to be marked is consequently the address of the start of the zone plus the fraction L(i−1)/n, where L is the length of the zone.

(c) Information Inserted into the Image by Digital Watermark

The first information to be inserted is the watermark identifier (WM-ID in six bytes) and the length of the data which follow (in bytes). This length (coded in 8 bits), which has to be recovered systematically, is marked in the start address zone: start address of the bitmap and of width 300h (the letter h means that the addresses are expressed in a hexadecimal system).

The remainder of the data is inserted into the zone comprised between the address 300h and the end address of the bitmap. This zone is composed of:

WM-DESCR (1 byte): access conditions descriptor, with the following bits:

b₀: screen copy inhibited

b₁: limitation of number of utilizations

b₂: restriction to certain users

b₃: reserved for a single user

b₄: reserved for a service

WM-MASK (1 byte): encipherment mask (index showing the degree of degradation of the image). It indicates to the equipment which are the scrambled bits in the bitmap:

00h: image not degraded

1Eh: weak degradation

3Eh: medium degradation

7Eh: strong degradation

FEh: total scrambling

The remaining data depend on selections performed during the acquisition of the access control parameters. Among the cases which can occur, the cases can be cited where there are specified:

a limited number of utilizations

a reserve awarded to a single user

a reserve for a particular service

a limited number of utilizations AND exclusiveness to one user

a limited number of utilizations AND exclusiveness to a service.

These cases can correspond to the following information:

Limited number of utilizations:

WM-NBMAX-UTIL (2 bytes): maximum number of utilizations (number of bits: 16)

WM-REF-IMAGE (2 bytes): image reference (number of bits: 16)

Exclusiveness to a single user

WM-REF-USER (2 bytes): user reference (number of bits: 16)

Exclusiveness to a service

WM-REF-SERVICE (8 bytes): service reference

Limited number of utilizations AND exclusiveness to a single user

WM-NBMAX-UTIL (2 bytes): maximum number of utilizations (number of bite: 16)

WM-REF-IMAGE (2 bytes): image reference (number of bits: 16)

WM-REF-USER (2 bytes): user reference (number of bits: 16)

Limited number of utilizations AND exclusiveness to a service

WM-NBMAX-UTIL (2 bytes): maximum number of utilizations (number of bits: 16)

WM-REF-IMAGE (2 bytes): image reference (number of bits: 16)

WM-REF-SERVICE (8 bytes): service reference

(d) Scrambling

In the application described, scrambling is obtained by means of an enciphering sequence initialized by a key. Six cases can be envisaged:

no access control criterion: the key is taken equal to 0.

limited number of utilizations: the key is taken equal to the image reference,

exclusiveness to one user: the key is taken equal to the user reference,

exclusiveness to a service: the key is a function of the service reference,

limited number of utilizations AND exclusiveness to one user: the key is the user reference.

The scrambling algorithm operates on all the bytes, carrying out an EXCLUSIVE-OR (XOR) logic operation between certain bits of the current byte and the corresponding bits of the enciphering byte of the enciphering sequence. This algorithm only operates on the 7 bits not used for the watermark, for example the 7 most significant bits, and never enciphers the least significant bit b₀, if it is that which can contain a bit of the digital watermark.

The access control information can contain the enciphered unscrambling key.

(e) User's Equipment

The user's equipment extracts the possible identifier WM-ID-LU of the watermark and verifies it. If this WM-ID-LU identifier does not correspond to the WM-ID of the algorithm, the image does not have access control information and is considered to have free accessibility.

If the WM-ID identifier is found, the equipment then extracts the complete watermark and operates chronologically in the following manner:

Verification of the correspondence of the recipient with the characteristics of the equipment; possible verification of the cryptographic seal (also termed “Hash”) if the number of utilizations is limited; if there is no agreement or the seal is false, the image is not unscrambled;

Verification of the number of utilizations of the image (and also its seal) if the number of utilizations is limited; if the maximum number of utilizations is exceeded, or if the seal is false, the image is not unscrambled;

Unscrambling of the image, using the key and mask described in the preceding paragraph.

In the case of an image for which a maximum number of utilizations has been fixed, the following information is written into the Windows registry during the first utilization:

user reference or service reference AND reference of the seal if a recipient is stated;

reference of the image AND of the seal;

With each new utilization of the image, the number of utilizations is decremented, the seal is recalculated, and the whole is written in the Windows registry. The seal algorithm used can be MD5.

If the image contains a screen copying inhibition, a hindrance order (“Hook”) is used to deactivate the call to this function.

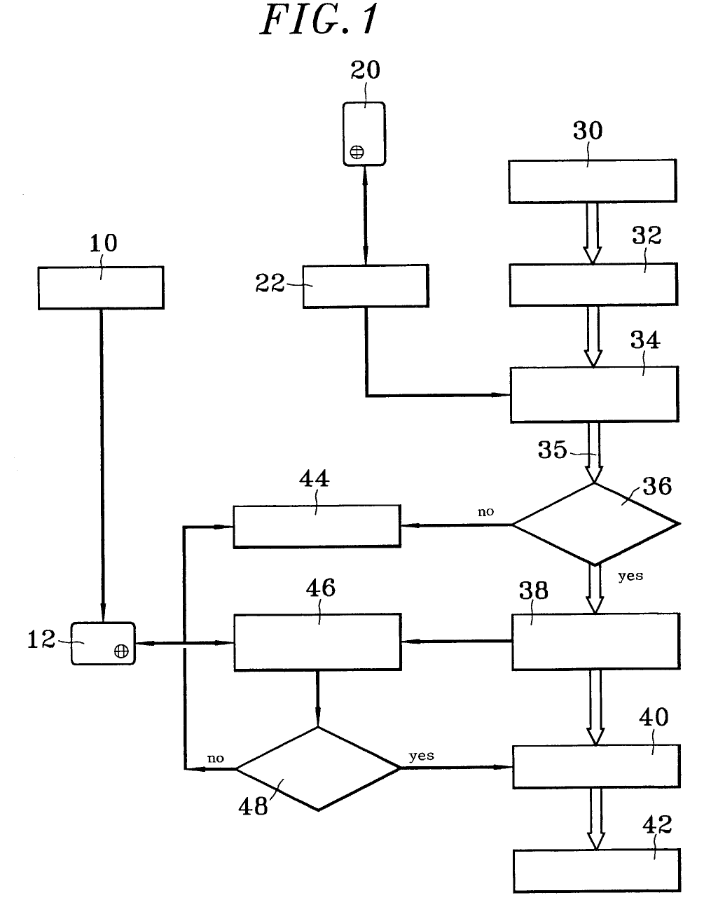

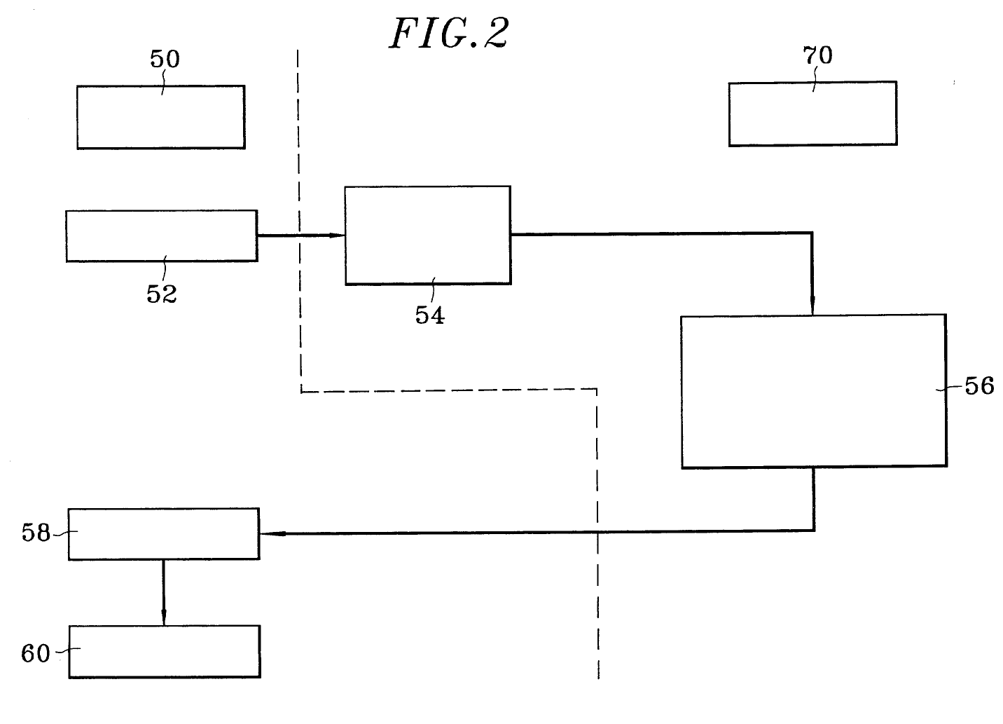

These different operations are illustrated schematically in FIGS. 1 and 2.

In FIG. 1, firstly, the block 15 denotes a rights server, which carries out the loading and management of the rights of the different users, symbolized by the card 12. This loading can take place in any manner: by wire, Hertzian means, etc. On the image supplier side, a card 20 is an external motherboard or a rights management means contained in the digital watermark application. This card controls a block 22 relating to access control. The digital data organized in the block 30 are degraded in the block 32. The access control data are then inserted into them (block 34), and the whole is broadcast as indicated symbolically by the arrow 35.

At the user station, the presence of data in the watermark is detected (36), and if this presence is detected, the data in question are extracted (38). If not, it is decided (44) to use the raw data. The extracted data are verified in block 46, which furthermore receives the rights written in the card 12. These rights then form the subject of a verification of access conditions (48). If the access conditions are verified, the data are unscrambled (40) and these unscrambled data are used to display the image (42). If the access conditions are not verified, use of the raw data is reverted to.

FIG. 2 illustrates more especially the principle of a secured service for the distribution of images on the Internet network. On the user's side, symbolized by the block 50, the first operation is an order (52) of an image. On the image server side, symbolized by the block 70, an image reference, a user reference, and access conditions are constituted (54). A degraded image is then produced, and in it there are inserted, by digital watermark, the image reference, the user reference, and the access conditions (block 56). The set of all these data is addressed to the user, where they are recorded in the file (58). The data are then processed and made use of (60) in the user's equipment.

1. Process of emission of information with access control, in which this information is transformed into digital data, these digital data are scrambled, the scrambled digital data are emitted, and access control information is furthermore emitted,
wherein the access control information is inserted into the scrambled digital data in the form of a digital watermark and the scrambled digital data with their digital watermark are emitted.

2. Process according to claim 1, wherein the access control information inserted in the form a digital watermark contain at least one of the following items of information:
an identifier of a digital watermark,
the length of the digital watermark,
access conditions descriptors.

3. Process according to claim 2, wherein the access control information inserted in the form of a digital watermark furthermore contain at least one of the following items of information:
a limited number of utilizations of the data,
a reserve awarded to a single user,
a reserve for a sole particular service authorized to receive the data,
a limited number of utilizations and an exclusiveness for a user,
a limited number of utilizations and an exclusiveness to a service.

4. Process according to any of claims 1-3, wherein, the scrambled digital information being organized in bytes, the access control information constituting the digital watermark being inserted into certain of these bytes, in the place of certain binary element(s) of these bytes.

5. Process according to claim 4, wherein the binary element of the bytes used for inserting the watermark is the least significant binary element of these bytes.

6. Process according to claim 4, wherein the scrambling of the digital data affects the binary elements of each byte other than the binary element(s) serving for the insertion of the watermark.

7. Process according to any of claims 4-6, wherein the bytes are 8-bit bytes.

8. Process according to any of claims 1-7, wherein the information relates to images.

9. Process according to claim 8, in which the access control information contains an instruction inhibiting the copying of the image.

10. Process according to claim 8, wherein the access control information contain an instruction deactivating screen copying.

11. Process according to claim 8, wherein the quality of the image is degraded by scrambling the digital data of the image.

12. Process according to claim 11, wherein the degradation of the quality of the image is effected by degrees, according to an index of scrambling.

13. Process according to claim 1, wherein the emission takes place by Hertzian means, or by wire, or by digital cable, or by a digital recording medium.

14. Process of reception of information with access control, this information having been emitted according to the process of any of claims 1-13, wherein the digital watermark is extracted from the digital data received and gives the access control information, and if access is authorized, the scrambled digital data are unscrambled to restore the information.

15. Process of emission/reception of information with access control, wherein the emission takes place according to the process of claim 1 across the Internet network by an image server and the reception takes place according to claim 14 by a user connected to the said Internet network.

16. Process according to claim 15, wherein:
the user orders an image on the image server,
the image server inserts a digital watermark in the digital data of the image, degrades the quality of the image by scrambling the digital data of the ordered image according to a selected scrambling index, and transmits the image having degraded quality with the digital watermark,
the user records the received data, restores its original quality to the image, and displays the ordered image.

17. Device for emission of information with access control for the implementation of the process according to claim 1, this device comprising means for transforming this information into digital data, means to scramble these digital data, means for emitting these scrambled digital data and for emitting access control information, wherein it comprises means for inserting the access control information into the scrambled digital data in the form of a digital watermark, the means for emission emitting the scrambled data with their digital watermark.

18. Device according to claim 17, comprising means for inserting a digital watermark into the data relating to an image, means for degrading the quality of the image by scrambling the digital data of the image according to a selected scrambling index, and means for emitting the data relating to the image having degraded quality, with the digital watermark.

19. Device for reception of information with access control for the implementation of the process according to claim 14, this device comprising means for reception of scrambled digital data and of access control information, means for verifying whether access is authorized, and means for unscrambling the received data if access is authorized, and means for restoring the information, wherein the means for reception is capable of extracting from the received digital data the digital watermark which they contain, for restoring the access control information.

20. Device according to claim 19, wherein the means for restoring the information are capable of restoring its original quality to an image having degraded quality.

21. System of information transmission with access control, wherein it comprises at least one device for emission according to claim 17 and a plurality of devices for reception according to claim 19.
